(19) United States
(12) Patent Application Publication
(10) Pub. No.: US 2006/0001406 A1
(43) Pub. Date: Jan. 5, 2006

(54) Power extractor circuit

(76) Inventor: Stefan Matan, Novato, CA (US)

Correspondence Address: Stefan Matan, 70 Sierra Vista, Novato, CA, 94948, US

(21) Appl. No.: 10/884,127

(22) Filed: Jul. 1, 2004

(51) Int. Cl. H02J 7/00

(52) U.S. Cl. 320/166

(57) ABSTRACT

The present invention discloses power extractor circuit used to capture the power of a solar cell array during its less-than-optimum conditions. Under reduced incident solar radiation, the low power level supplied by the solar cell array normally would not be adequate to operating a load, but with the presence of the power extractor circuit, the low power generated by the solar panel would be accumulated to a high enough level to overcome the energy barrier of the battery or the load. The power extractor circuit preferably comprises a voltage and current booster circuit, and is designed to operated at all power levels of the solar cell array: low power level to provide the booster function during the low power period of the solar cell array, and high power level to prevent component failure during the normal operation of the solar cell array. Many power extractor circuits can also be installed in series to cover a wide range of power level of the solar cell array. The present invention power extractor circuit can also be used in other power sources to utilize the portion of power which normally would have been lost.

### FIELD OF THE INVENTION

This invention relates generally to a method and apparatus for harvesting power in the low power regimes from a power source and, more particularly, to a method and apparatus that delivers power output of a photovoltaic array during varying ambient weather conditions.

### BACKGROUND OF THE INVENTION

Solar power is one of the clean and renewable sources of energy (the others being wind, geothermal steam, biomass, and hydroelectric) that have mass market appeal. Solar power uses energy from the sun to provide passive heating, lighting, hot water, and active production of electricity through photovoltaic solar cells. Photovoltaics are the most promising of active solar power which directly convert sunlight into electricity. However, photovoltaics are very expensive, in terms of high production cost and low efficiency.

Significant works have been done to improve the efficiency of the photovoltaic array. One of the earliest improvements is the addition of a battery. Without the battery, the photovoltaic array can supply electrical power directly to a load. The major drawback of this configuration is the uneven distribution of solar energy: during daylight operation, the photovoltaic array can produce excess power while during night time or periods of reduced sun light, there is no power supplied from the photovoltaic array. With the addition of a battery, the battery can be charged by the photovoltaic array during periods of excessive solar radiation, e.g. daylight, and the energy stored in the battery can then be used to supply electrical power during nighttime.

Single solar cell normally produces voltage and current much less than the typical requirement of a load. A photovoltaic cell typically provides 0.2-1.4 V and 0.1-5 A, depending on the photovoltaic cell and its operating conditions, e.g. direct sun light, cloudy, etc., while the load might need about 5-48 V, 0.1-20 A. Thus a number of photovoltaic cells are arranged in series to provide the needed voltage requirement, and arranged in parallel to provide the needed current requirement. These arrangements are critical since if there is a weak cell in the formation, the voltage or current will drop and the solar cell array will not be functioning properly. Thus for example, it is normal to see a photovoltaic array arranged for 17 V to provide 12 V to a battery. The additional 5 V provides a safety margin for the variation in solar cell manufacturing and solar cell operation, e.g. reduced sun light conditions.

Since the current produced by these photovoltaic cell arrays is constant, in the best of lighting condition, the photovoltaic array loses efficiency due to the fixed voltage of the battery. For example, a photovoltaic array rated 75 W, 17 V will have a maximum current of 75/17=4.41 A. During direct sunlight, the photovoltaic array produces 17 V and 4.41 A, but since the battery is rated at 12V, the power transferred is only 12*4.41=52.94 W, for a loss of about 30%. This is a significant power loss; however, it is not desirable to reduce the maximum possible voltage provided by the photovoltaic array because in the reduced sunlight condition, the current and voltage produced by the photovoltaic array will drop due to low electron generation, and thus might not able to charge the battery. FIG. 1 shows a piort art Voltage-Current output of a photovoltaic cell, showing that charging batteries directly from the photo cells might not yield optimum result. In this IV curve, it is indicated that improved photo cells can have an advantage over standard cells, and that improved photo cell technology could produce higher power output. However, optimum power is still not being delivered to the battery. The “Battery Charging Window” is located considerably below the knee of the curve, which is the optimum power point.

In order to improve the efficiency of the photovoltaic array, a method of Maximum Power Point Tracking (MPPT) is introduced where the voltage provided by the photovoltaic array is tracked and converted to the battery voltage by a DC-to-DC converter before the power is supplied to the battery. This MPPT method can recover the 30% power loss, provided that the power consumed by the MPPT circuitry is not excessive.

Together with MPPT technique, various methods and circuits have been developed to improve the efficiency and applications of solar cell array. For example, if a supply of 5V is needed from a low voltage solar cell of 3 W (1 V, 3 A), a voltage booster circuit is required to bring the solar cell voltage to 5 V to operate the load.

However, the basic assumption of all these methods and circuits is always that the photovoltaic array can produce at least the necessary power to operate the battery or the load, 75 W in the MPPT example, and 3 W in the 5 V application. So far, no circuit has been designed to capture the power of a solar cell during the reduced sunlight conditions. The conclusion is almost always that the solar cell would not operate under low sunlight conditions such as when it is cloudy, in the evening or at night.

### SUMMARY OF THE INVENTION

Under reduced incident solar radiation, the solar cell array does not receive enough sunlight to produce adequate power to charge the battery or to power a load, and therefore the solar cell array is inactive and the power generated by the solar panel is lost.

The present invention power extractor circuit is designed to capture the power generated from the solar panel that would have been lost under these circumstances. The basic concept of the present invention power extractor circuit is to collect and accumulated a number of small-power packets from the solar panel (or any power sources) and then use the accumulated power to power a load or to charge a battery. By itself, the individual small-power packet is not adequate for any useful work such as charging the battery or powering a load because of low voltage or low current or both. By the accumulation of many small-power packets, the collected power would be high enough to charge the battery or power a load. The number of packets needed to be accumulated depends on the applications, but in general should be at least enough to do useful work. Thus by capturing many small packets of low power and accumulating them to form a packet of high power, high enough to charge the battery or operate a load, the present invention power extractor circuit can utilize the low power generated by the solar panel under reduced incident solar radiation.

The power extractor circuit preferably comprises a voltage and current booster circuit. The voltage booster circuit is used to generate higher voltage and the current booster circuit to generate higher current. The power extractor circuit also is preferably designed to operate at all power levels of the solar cell array, providing the booster function at low power level during the low power period of the solar cell array, and preventing component failure at high power level during the normal operation of the solar cell array. The power extractor can further comprise a circuit breaker to prevent damage to the power extractor circuit at high power. Furthermore, many power extractor circuits can also be installed in series to cover a wide range of power level of the solar cell array.

The present invention power extractor circuit can also be used in other power sources to utilize the portion of power which would normally be lost.

### BRIEF DESCRIPTION OF THE DRAWINGS

FIG. 1 shows a prior art battery charging voltage from solar module.

FIG. 2 shows an exemplary prior art solar power supply system.

FIG. 3 shows an embodiment of the present invention in solar cell system.

FIG. 4 shows a basic configuration of a power extractor circuit.

FIG. 5 shows a transformer flyback topology of a power extractor circuit.

FIG. 6 shows an embodiment of the present invention using a transistor as a switch in the power extractor circuit.

FIG. 7 shows an exemplary circuit of a pulse width modulation.

FIG. 8A shows the pin out of a 555 timer chip.

FIG. 8B shows an exemplary circuit of a 555 timer circuit for monostable operation.

FIG. 9 shows an exemplary circuit of a 555 timer circuit for astable operation.

FIG. 10 shows an exemplary circuit of the present invention power extractor circuit using a 555 timer circuit.

FIG. 11 shows an embodiment of the present invention for 2 cascading power extractor circuits.

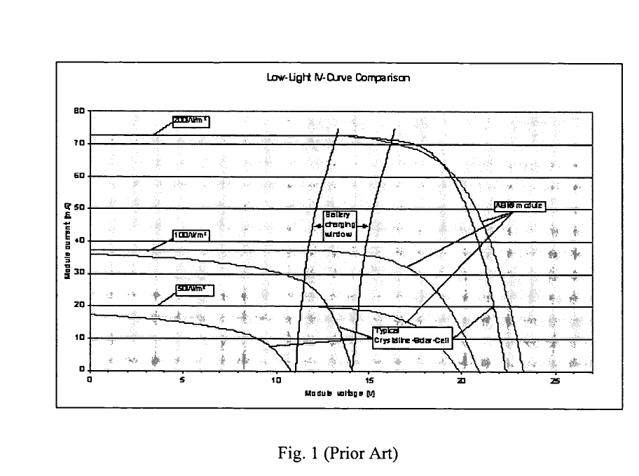

### DETAILED DESCRIPTION OF THE INVENTION

Solar cell arrays are excellent source of power since they can be operated anywhere under sunlight. However, improving the efficiency of the solar cell array is a major concern since solar cell array normally does not operated under low light conditions. Specifically, since almost all solar cell arrays come with a rechargeable battery, under the weather conditions that do not allow the solar cell array to produce adequate power to charge the battery, the solar cell array is inactive.

The present invention discloses a circuit to improve the efficiency of a solar cell array, and specifically to operate the solar cell array under low light conditions. The present invention is also suitable for low quality solar cells and flexible solar cells, because even in the best sunlight conditions, many of these solar cells could still produce less power, as much power as the high quality, single crystal silicon solar cells under low light conditions.

The basic component of the present invention is a power extractor circuit that extracts many of the low power packets generated by the solar cells under low sunlight condition, puts them into an accumulator, and then use the power in the accumulator to charge the battery. The power from the accumulator can also be used to power a load, as long as the load is designed to withstand the cyclic nature of the power supply from the accumulator, meaning a cycle of the accumulator being charged with the many power packets, and then discharged to the load.

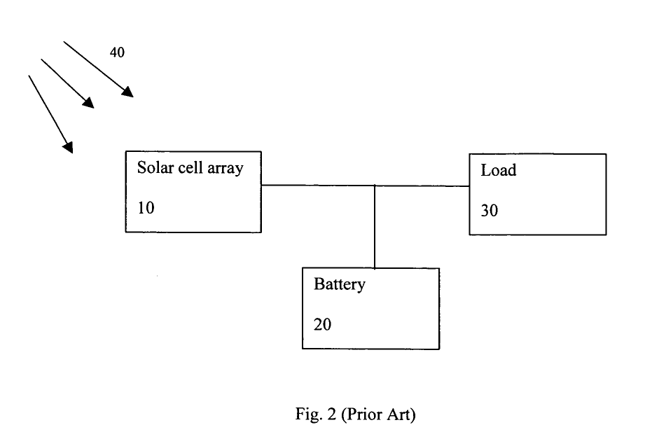

FIG. 2 shows an examplary prior art solar cell power supply system. In this configuration, the solar cell 10 provides power to a battery 20 and a load 30. The battery 20 and load 30 is designed for 12 VDC, and therefore would not operate at much lower operational voltage than 12 V. The solar cell is typically rated at 17 V under direct full sun light 40. Thus under optimum sun light, the configuration would need a MPPT circuit for best efficiency. However, when the sun light 40 drops, for example in a cloudy weather, the solar panel 10 might only produce less than 12 V, for example 10V. Under this condition, the solar panel becomes inoperative, and the load 30 is operated by the battery 20. Thus the power generated by the solar panel from 0 V to 12 V in this configuration would be wasted.

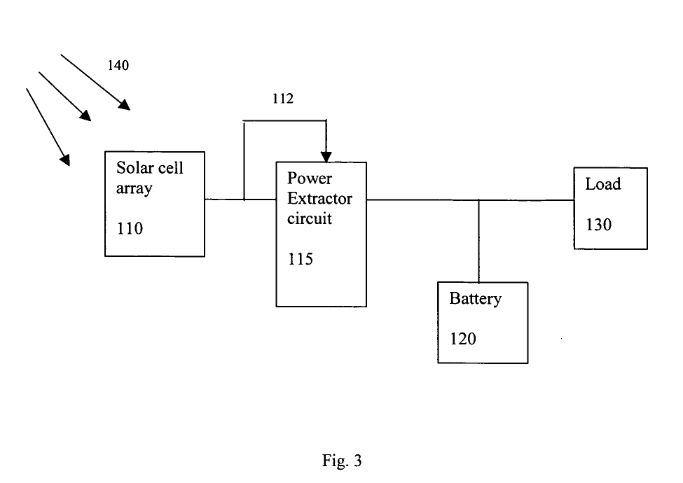

FIG. 3 shows a first embodiment of the present invention power extractor circuit. The power extractor circuit 115 is disposed between the solar panel 110 and the battery 120 and the load 130. The power extractor circuit 115 further takes power through a power line 112 from the solar panel 110 to operate its internal circuitry. The power extractor circuit comprises an accumulator, a voltage booster or a current booster, and is designed to accumulate the low power packets from the solar panel to a level that can operate the load or charge the battery. For example, suppose that the weather is cloudy and the solar panel only produces 5 V, 1 mA output. Without the power extractor circuit, this solar panel would not be able to charge the battery or operate the load which requires power higher than 5 mW. The present invention power extractor circuit would take many power packets of, for example, 5 V, 1 mA and put them in an accumulator. After accumulating enough power packets, the accumulator would have enough power, voltage or current, for example 30 V, 5 mA, to charge the battery or to power the load. The power extractor circuit does not increase the power generation of the solar panel, it only accumulates enough power packets to overcome the energy barrier before delivering the power. Thus the power extractor circuit is preferably used to charge a battery, or to operate cyclic-designed load due to the characteristics of the power extractor circuit.

Another characteristic of the present invention power extractor circuit is its power requirement. Even though the power extractor circuit is connected to the solar panel and the battery and load with all of these components rated at high power (12-17 V in the above example), the power extractor circuit is designed to operated at a much lower power, 4-5 V power supply or even lower in the above example. The reason is that the power extractor circuit really operates when the power level of the solar panel goes down, and not when the solar panel is at its peak power. However, the power extractor circuit also needs to sustain the high power of the solar panel at its peak. Therefore for a solar panel rated at 17 V, to capture the power in the range of 4.5 V to 12 V, the power extractor circuit needs to be designed to operate in the range of 4.5 to 18 V.

In another embodiment, the power extractor circuit can further comprise a circuit breaker to prevent damage to the power extractor circuit at high power. For example, the above power extractor circuit can operate in the range of 4.5 to 12 V with a circuit breaker to disconnect and bypass the power extractor circuit and directly connect the solar panel to the battery and load. Since at high power level, the usefulness of the power extractor is limited, the disconnection and bypassing of the power extractor circuit would not reduce the overall efficiency of the solar panel circuit.

In further other embodiment, the power extractor circuit can be cascaded to further extract a wider range of power from the solar panel. For example, a power extractor operated in the range of 0.3 to 4.5 V can be cascaded with another power extractor operated in the range of 4.5 to 17 V. That way a 17 V solar panel connecting to a 12 V battery can be extracted of its power in the range of 0.3 to 17 V.

The above discussion focuses on the solar cell power extraction, but the present invention power extraction circuit is not limited to just solar power, but can be applied toward any electrical power supply. For example, a run-down battery would not operate the load it is connected to, but with the power extraction circuit, after a period of power accumulation, the battery can supply enough power to operate the load for a short while. Also by connecting many run-down batteries in parallel, the power extraction circuit would accumulate enough power to operate the load for some time. Another application is hydroelectric power which uses flowing water to generate electricity. During the period of reduced water flow that is not enough to charge the existing load, the present invention power extraction circuit could extract and store the hydro power that otherwise might be lost. Still another application is wind power which uses air flow to generate electricity. During the period of low wind that is not enough to charge the existing load, the present invention power extraction circuit could extract and store the wind power that otherwise might be lost. Still another application is fuel cell technology. During the period of sleeping mode, the fuel cell generates too little power for the existing load. Using the present invention power extraction circuit, the power generated from fuel cells during the low power period can be extracted and stored.

The fundamental of the present invention is the concept of accumulating many small power packets, and then use the collection of these power packets to power a load or charge a battery. The accumulation step comprises the steps of collecting a packet of power from the solar cell or a power source, and then putting this packet of power into an accumulator. These steps of collecting power and putting it into the accumulator are repeated until there are enough power in the accumulator to power a load or to charge a battery. Then the power in the accumulator is used to power the load or to charge the battery. And the cycle repeats again. By collecting and accumulating small power packets, small enough so that by themselves, these power packets are practically useless and cannot be used for anything, the accumulation of these power packets can form a significant amount of power, high enough to be useful.

Thus the concept of the present invention power extractor circuit fits very well with the idea of a voltage booster circuit. In a typical DC-to-DC voltage booster circuits, power is charged to an inductor and then discharged to a capacitor where the power is accumulated. But unlike the voltage booster circuit in that the booster circuit preserves the power, meaning increasing the voltage while keeping constant the product of voltage and current; the present invention power extractor circuit preserves only the work, meaning the product of power and time. Thus the power extractor circuit in the present invention can increase the power level at the expense of time. The present invention uses the idea of a voltage booster, but provides a new and different inventive concept of harnessing small power packets and by accumulating these power packets, the resulting combined power packets can be used.

The accumulated power can have higher voltage and higher current. Thus the present invention can comprise a voltage booster and a current booster. The preferred configuration is a voltage booster, and with a transformer having a high ratio of primary coil to secondary coil, the current can also be boosted to a higher level. Thus even though the present invention uses the concept of a voltage booster, the result is much different since the power extractor circuit produces power in burst mode, higher power level than the input power but in a shorter time.

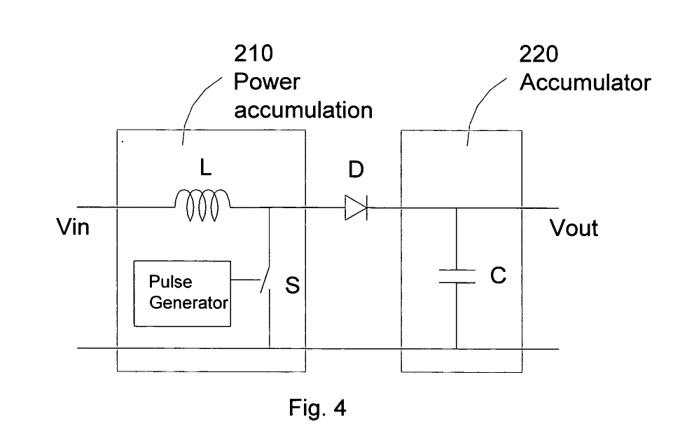

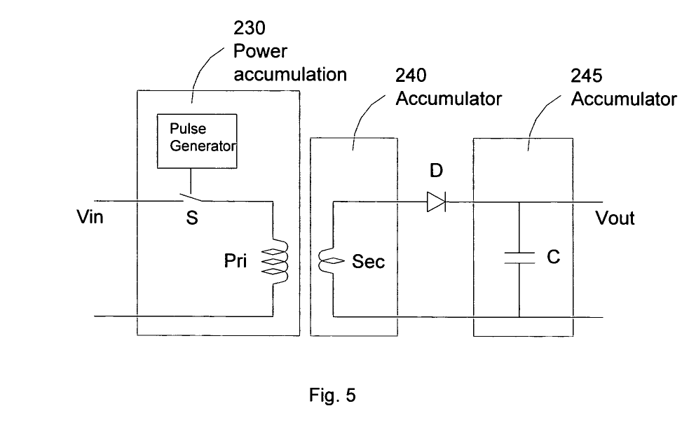

Voltage booster circuit has been employed extensively in the DC-to-DC converter. If n capacitors connected in parallel are charged, a voltage V will appear across each capacitor. If then these capacitors are re-arranged serially, the total voltage will increase to nV. A better basic power extractor configuration is shown in FIG. 4 (employing the basic voltage booster configuration), which comprises an inductor L, a switch S, a diode D and an accumulator capacitor C. The switch S is normally controlled by a pulse generator. The inductor L, the switch S and the pulse generator make up the first component power accumulation 210 of the power extractor circuit, and the capacitor C makes up the second component accumulator 220. If the switch S has been open for a long time, the voltage across the capacitor C is equal to the input voltage. When the switch closes (charge phase), the power is stored in the inductor L and the diode D prevents the capacitor C from being discharged. When the switch opens (discharge phase), the power stored in the inductor L is discharged to and accumulated in the capacitor C. If the process of opening and closing the switch is repeated over and over, the voltage across the capacitor C will rise with each cycle. DC-to-DC converter normally employs some feedback and control to regulate the output voltage, but the power extractor might or might not need any feedback. The main concern of the power extractor is the accumulation of power packets and thus the accumulated power level, which might be too high and results in the breakdown of individual component. The basic power extractor circuit can have a variety of configuration such as swapping the inductor and the diode yielding the inverting topology, or a boost transformer fly back topology yielding the boost, inverting and isolating output voltage. FIG. 5 shows the power accumulation 230 comprising a primary coil Pri of the transformer and a switch S controlled by a pulse generator, together with either an accumulator 240 which is the secondary coil Sec of the transformer or an accumulator 245 which is a capacitor C or both. The power extractor circuit typically comprises a switch and an inductor, and in the transformer flyback topology, the primary coil of the transformer is the inductor of the power extractor circuit. The capacitor or the secondary coil of the transformer serves as an accumulator. By using a high ratio of primary coil to secondary coil of the transformer, the power extractor circuit can boost the current level supplied to the accumulator, e.g. the secondary coil or an extra capacitor in parallel with the secondary coil.

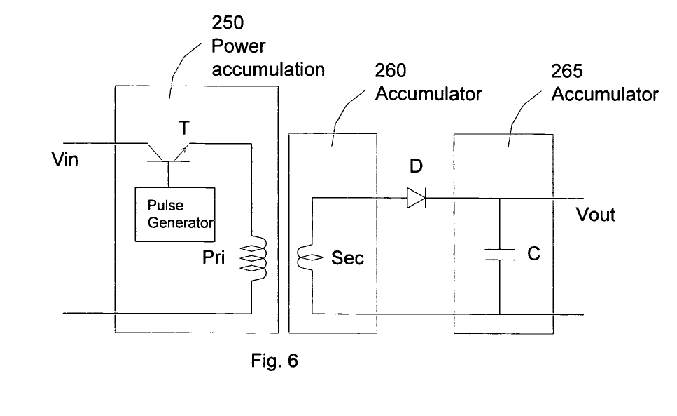

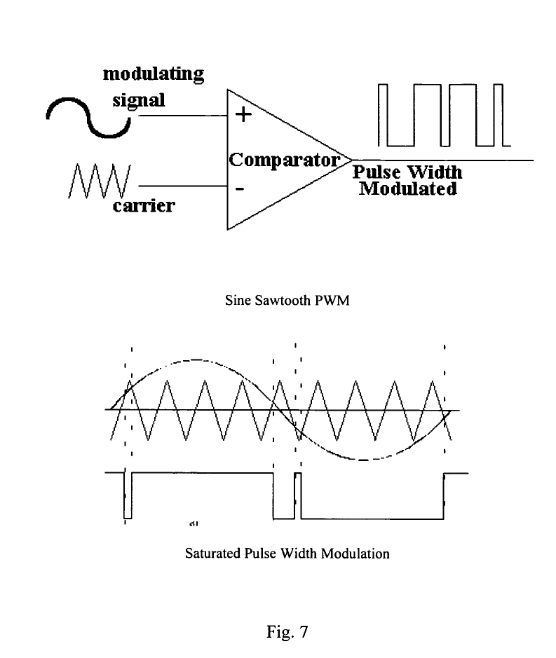

The switch in the power extractor circuit can be a transistor connected across the source and drain (or emitter/collector) with the gate (or base) controlled by a pulse signal generator. FIG. 6 shows the power accumulation 250 comprising a primary coil Pri of the transformer and a transistor switch T controlled by a pulse generator, together with either an accumulator 260 which is the secondary coil Sec of the transformer or an accumulator 265 which is a capacitor C or both accumulators 260 and 265. Popular control techniques include pulse-frequency modulation, where the switch is cycled at a 50% duty cycle; current-limited pulse-frequency modulation, where the charge cycle terminates when a predetermined peak inductor current is reached, and pulse-width modulation, where the switch frequency is constant and the duty cycle varies with the load. FIG. 7 shows an examplary circuit of a pulse width modulation, employing a comparator having a sawtooth signal and a modulating sine signal. The output signal of the comparator goes high when the sine wave is higher than the sawtooth.

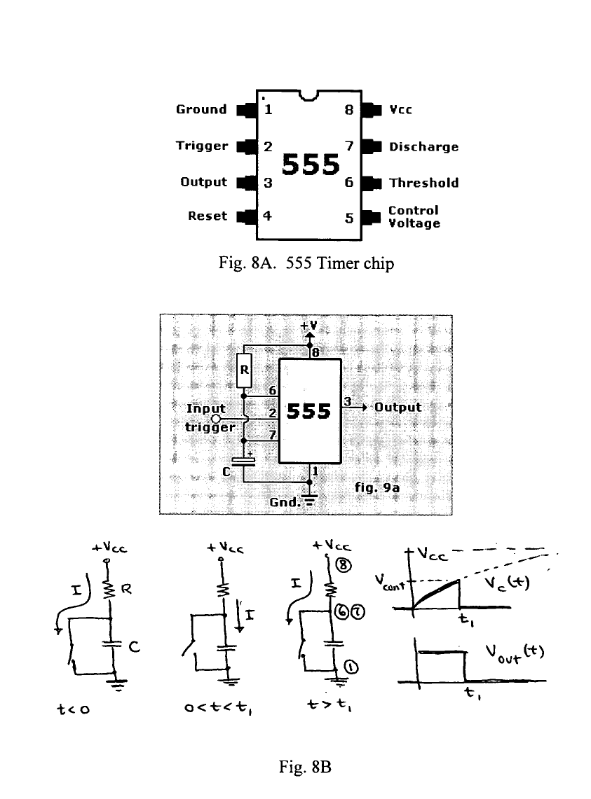

Pulse generator is also a basic component of the power extractor circuit. There are various circuit configuration for a pulse generator. One basic pulse generator configuration is the timer circuit, employing a chip such as the 555 timer chip, shown in FIG. 8A. Many of the timing calculations for circuits using the 555 timer are based on the response of a series R-C circuit with a step or constant voltage input, and an exponential output taken across the capacitor. The two basic modes of operation of the 555 timer are (1) monostable operation, in which the timer wakes up and generates a single pulse, then goes back to sleep, and (2) astable operation, in which the timer is trapped in an endless cycle—generates a pulse, sleeps, generates a pulse, sleeps, . . . on and on forever.

The monostable (one-pulse) operation can be understood as consisting of these events in sequence (circuit shown in FIG. 8B):

0. (up to t=0) A closed switch keeps the C uncharged: V_{c}=0, Vₒᵤₜ is low.

1. (at t=0) A triggering event occurs: V_{trigger} drops below V_{control}/2, very briefly. This causes the switch to open.

2. (0<t<t₁) V_{c}(t) rises exponentially toward V_{cc} with time constant RC. Vₒᵤₜ is high.

3. (at t=t₁) V_{c} reaches V_{control}. This causes the switch to close, which instantly discharges the C.

4. (from t=t₁ on) A closed switch keeps the C uncharged: V_{c}=0, Vₒᵤₜ is low.

The astable (pulse train) operation, shown in FIG. 8, can be understood as consisting of these events, starting at a point where V_{c}=V_{control}/2:

1. (at t=0) V_{c}=V_{control}/2, and the switch opens.

2. (0<t<t₁) V_{c}(t) rises exponentially toward V_{cc} with time constant (R₁+R₂)C. Vₒᵤₜ is high.

3. (at t=t₁) V_{c} reaches V_{control}. This causes the switch to close.

4. (t₁<t<t₁+t₂) V_{c}(t) falls exponentially toward zero with time constant R₂C. Vₒᵤₜ is low.

5. (at t=t₁+t₂=T) V_{c} reaches V_{control}/2. This causes the switch to open. These conditions are the same as in step 1, so the cycle repeats every T seconds. (Go to step 2.)

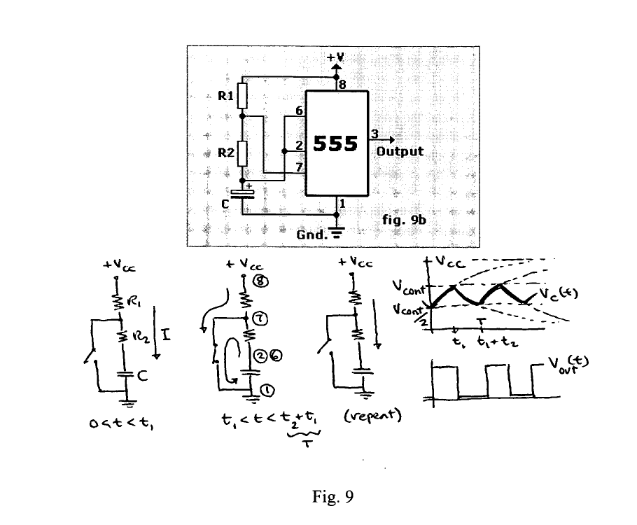

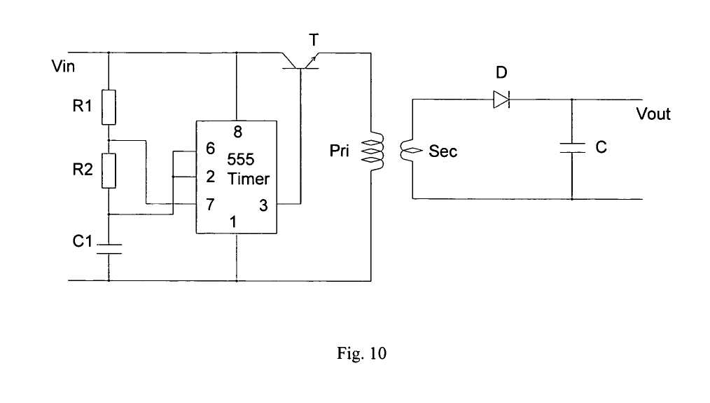

Using the 555 timer circuit of FIG. 9, an embodiment of the present invention is shown in FIG. 10. The circuit uses a transformer flyback topology to isolate the output, it can also provide higher current to charge the capacitor.

The 555 timer is particular suitable for the 17 V solar panel, since the voltage rating of the 555 timer is between 4.5 V and 18 V. Thus the embodiment of FIG. 9 can be operated at the incident solar radiation down to 4.5 V operation of the solar panel, providing power that a normal solar panel cannot do.

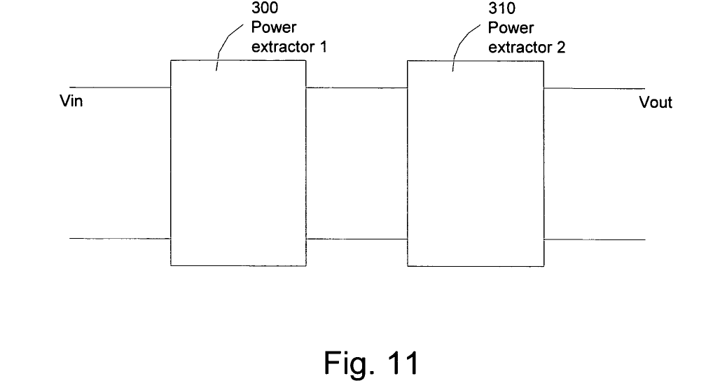

For further operation down to 0.3 V operation of the solar panel, an oscillator that operates at lower voltage is needed. A ring oscillator that can operate at not more than 0.4 or 0.5 V (U.S. Pat. No. 5,936,477 of Wattenhofer et al.) will be needed to provide the booster circuit at low power level. FIG. 11 shows two cascading power extractor circuit 300 and 310 connecting in series to cover the voltage range needed. Cascading and circuit breaker might be further needed to ensure proper operation.

Further components of a solar power can be included, for example a battery charger that uses a pulse-width-modulation (PWM) controller and a direct current (DC) Load Control and Battery Protection circuit, an inverter for generating AC voltages to operate conventional equipment, etc.

During use, the solar cells can be spread open to increase their light receiving area for use in charging a battery pack, and it can be folded into a compact form to be stored when not in use. Since the solar cells are thin, the solar cell cube is relatively compact. The solar cells may be made larger by increasing the number of amorphous silicon solar cell units. A plurality of solar cells may also be connected electrically by cables or other connectors. In this fashion, solar cell output can easily be changed. Hence, even if the voltage or capacity requirement of a battery changes, the charging output can easily be revised to adapt to the new requirement. The present invention charger technology can also adjust the “Battery Charging Window” by utilizing techniques in power supply switching technology so that the charging window is located closer to the maximum efficiency point on the IV curve of the solar cell. The power generated is then used to either charge the reserve batteries or extend the discharged time while the batteries are at full charge and under load.

The present invention is also particular suitable for low cost solar cells since these solar cells tend to produce less power and are not as efficient as the high cost ones. Flexible solar cells, plastic solar cells are examples of low cost solar cells that can benefit from the present invention power extraction circuit.

The circuit is tailored for each battery technology, including nickel cadmium (Ni—CD) batteries, lithium ion batteries, lead acid batteries, among others. For example Ni—CD batteries need to be discharged before charging occurs.

It will be apparent to those skilled in the art that various modifications and variation can be made in the present invention without departing from the spirit or scope of the invention. Thus, it is intended that the present invention covers the modifications and variations of this invention provided they come within the scope of the appended claims and their equivalences.

What is claimed is:

1. A power extraction circuit to extract power from a power source during the period of power capacity not adequate to powering a load or to charge a battery, the circuit comprising
an electrical accumulator; and
a power accumulation circuit connected between the power source and the accumulator for charging the accumulator to at least a load-operatable or battery-chargeable power,
wherein the electrical power in the accumulator can be used to power a load or to charge a battery.

2. A power extraction circuit as in claim 1, wherein power accumulation circuit receives power from the power source, and is able to operate even when the power, voltage or current level of the power source drops off substantially below its nominal value.

3. A power extraction circuit as in claim 1, wherein the power accumulation circuit comprises a voltage booster circuit.

4. A power extraction circuit as in claim 1, wherein the power accumulation circuit comprises a current booster circuit.

5. A power extraction circuit as in claim 1, wherein the power accumulation circuit comprises a combination of voltage booster and current booster circuit.

6. A power extraction circuit as in claim 1, wherein the power accumulation circuit is controlled by a pulse signal generator having a predetermined frequency supplied by an oscillator.

7. A power extraction circuit as in claim 1, wherein the power accumulation circuit comprises an inductor and a switching circuit operated by a pulse signal generator.

8. A power extraction circuit as in claim 1, wherein the power accumulation circuit comprises a primary coil of a transformer and a switching circuit operated by a pulse signal generator.

9. A power extraction circuit as in claim 8, wherein the switching circuit comprises a switching transistor whose source-drain path is connected between the power source and the transformer and whose gate is connected to the output of a pulse signal generator.

10. A power extraction circuit as in claim 1, wherein the accumulator comprises a secondary coil of a transformer.

11. A power extraction circuit as in claim 1, wherein the accumulator comprises a capacitor.

12. A power extraction circuit as in claim 1, wherein the pulse signal generator is a ring oscillator.

13. A power extraction circuit as in claim 1, wherein the pulse signal generator is an astable timer.

14. A power extraction circuit as in claim 1, wherein the pulse signal generator comprises a RC timer circuit.

15. A solar power extraction circuit to extract power from a solar power source to power a load or to charge a battery during the period of low incident solar radiation not adequate to power the load or to charge the battery, the circuit comprising
an electrical accumulator; and
a power accumulation circuit connected between the solar power source and the accumulator for charging the accumulator to at least a load-operatable or battery-chargeable power,
wherein the electrical power in the accumulator can be used to power a load or to charge a battery.

16. A solar power extraction circuit as in claim 15, wherein power accumulation circuit receives power from the solar power source, and is able to operate even when the power, voltage or current level of the solar power source drops off substantially below its nominal value.

17. A solar power extraction circuit as in claim 15, wherein the power accumulation circuit comprises a voltage booster circuit.

18. A solar power extraction circuit as in claim 15, wherein the power accumulation circuit comprises a current booster circuit.

19. A solar power extraction circuit as in claim 15, wherein the power accumulation circuit comprises a combination of voltage booster and current booster circuit.

20. A solar power extraction circuit as in claim 15, wherein the solar power source is operated by photo-voltaic conversion.

21. A solar power extraction circuit as in claim 15, wherein the power accumulation circuit is controlled by a pulse signal generator having a predetermined frequency supplied by an oscillator.

22. A solar power extraction circuit as in claim 15, wherein the power accumulation circuit comprises an inductor and a switching circuit operated by a pulse signal generator.

23. A solar power extraction circuit as in claim 15, wherein the power accumulation circuit comprises a primary coil of a transformer and a switching circuit operated by a pulse signal generator.

24. A solar power extraction circuit as in claim 15, wherein the power accumulation circuit comprises a primary coil of a transformer, a switching circuit operated by a pulse signal generator, and a diode.

25. A solar power extraction circuit as in claim 24, wherein the switching circuit comprises a switching transistor whose source-drain path is connected between the power source and the transformer and whose gate is connected to the output of a pulse signal generator.

26. A solar power extraction circuit as in claim 15, wherein the accumulator comprises a secondary coil of a transformer.

27. A solar power extraction circuit as in claim 15, wherein the accumulator comprises a capacitor.

28. A solar power extraction circuit as in claim 15, wherein the pulse signal generator is a ring oscillator.

29. A solar power extraction circuit as in claim 15, wherein the pulse signal generator is an astable timer.

30. A solar power extraction circuit as in claim 15, wherein the pulse signal generator comprises a RC timer circuit.

31. A solar power extraction circuit as in claim 15, wherein the power accumulation control technique comprises pulse-frequency modulation.

32. A solar power extraction circuit as in claim 15, wherein the power accumulation control technique comprises pulse-width modulation.

33. A solar power extraction circuit as in claim 15, wherein the power accumulation circuit comprises the series connection of a transformer and a switching circuit.

34. A method to improve the efficiency of a power source by the extraction of power from the power source during the period of power capacity not adequate to powering a load, the method comprising
accumulating power from the power source by
collecting a packet of power from the power source,
putting the packet of power into an accumulator, and
repeating the collection of power packet until the accumulator has adequate power to power a load; and
using the accumulated power to power a load.

35. A method as in claim 34 wherein the accumulation of power is accomplished by DC-to-DC voltage boosting convertion.

36. A method as in claim 34 wherein the power source is a solar cell array.

37. A method as in claim 34 wherein the power source is a solar cell array and the period of power capacity not adequate to powering a load or charging a storage element of the solar cell array is when there is not adequate incident solar radiation to the solar cell array.

38. A method as in claim 34 wherein a load comprises a battery with powering the load comprising charging the battery.

39. A method as in claim 34 wherein the above steps are repeated.
